(19) United States
(12) Patent Application Publication
(10) Pub. No.: US 2025/0084539 A1
(43) Pub. Date: Mar. 13, 2025

(54) Device and Method for Large Scale Harvesting of Solar Energy Through Hydrogen Production

(71) Applicant: Vivek Pathak, East Brunswick, NJ (US)

(72) Inventor: Vivek Pathak, East Brunswick, NJ (US)

(21) Appl. No.: 18/913,300

(22) Filed: Oct. 11, 2024

Related U.S. Application Data
(63) Continuation-in-part of application No. 17/146,390, filed on Jan. 11, 2021, now Pat. No. 12,116,679.
(60) Provisional application No. 62/959,957, filed on Jan. 11, 2020.

(51) Int. Cl. C25B 1/04; C25B 1/55; C25B 9/05; C25B 9/50; C25B 9/60; H02S 10/20; H02S 20/32; H02S 30/20; H02S 40/22

(52) U.S. Cl. CPC C25B 1/04; C25B 1/55; C25B 9/05; C25B 9/50; C25B 9/60; H02S 10/20; H02S 20/32; H02S 30/20; H02S 40/22

(57) ABSTRACT

Large scale harvesting of renewable energy is proposed by using floating devices which use solar, wind, ocean current, and wave energy to produce compressed hydrogen by electrolysis of deep sea water. Natural ocean currents and winds are used to allow the devices to gather energy from over a large area with minimum transportation cost. The present approach uses a combination of well understood technologies in an optimized manner and at scale. Hydrogen produced in this manner would pave the way for carbon free energy economy.

### CROSS REFERENCE TO RELATED APPLICATIONS

This application is a continuation-in-part of U.S. patent application Ser. No. 17/146,390, filed on Jan. 11, 2021, which claims the benefit of U.S. Provisional Application No. 62/959,957 filed Jan. 11, 2020, the disclosures of which are hereby incorporated by reference in their entireties.

### BACKGROUND OF THE INVENTION

This invention refers to large scale and cost effective harvesting and transporting of renewable energy: solar, wind, wave, ocean-current, tidal-current, and lightning energy from the ocean or other water bodies with the harvested energy being stored and transported in the form of compressed Hydrogen, solid metal hydride, and/or a charged battery.

Adoption of solar power for transportation and industrial usage requires addressing the lower energy density and the inherent unreliability of solar power, which make it less suitable for transportation and industrial usage, unless storage can smooth out the unavailability caused by intermittent nature of incoming solar energy. The low energy density of sunlight requires a large collection area. If large geographical areas are used for solar energy production, then there is a problem of transporting the energy to where it is needed. Transporting the harvested solar energy to the point of consumption additionally expends energy. Thus the effective yield of harvested energy is reduced. Improving the efficiency of storage and transportation is therefore of paramount importance in solar energy harvesting. These issues also apply to harvesting and transporting other forms of renewable energy, e.g.: wind, wave, ocean-current, tidal-current, and lightning.

Among the upcoming non-carbon based fuels, hydrogen is well matched to the existing transportation infrastructure. Given a cost-effective and large scale supply of compressed hydrogen fuel, it is feasible to rapidly migrate out of gasoline and diesel in a non-disruptive manner. Among the recent attempts at extracting oceanic solar energy, extracting hydrogen from water for energy usage, the following are salient:

US patent U.S. Pat. No. 9,315,397B2 by Samuel Sivret proposes electrolysis of sea water at depth to create hydrogen and oxygen. A stationary system of pumps and turbines is used to generate hydrogen and oxygen by electrolysis of water. Having a fixed infrastructure approach limits the total energy one can gather from the invention unless a cheap and abundant power supply source is assumed.

International patent WO2015163932A1 by Joseph P. BOWER proposes electrolysis of water under pressure within a fixed chamber to generate hydrogen by electrolysis of water. Again a fixed infrastructure approach makes it unsuitable for application in solar energy harvesting.

US patent US010411643 by Smadja et. al. describes floating solar arrays with ability to orient the solar cells to improve the efficiency of photovoltaic generation of electricity. Having moving parts that need continuous solar tracking makes the approach less pragmatic for large ocean environment, which would be required if significant amount of hydrogen has to be generated.

US patent US010840572 by Denis Luz addresses the storage aspect by converting solar energy into compressed hydrogen for later use. However the approach is one of a fixed infrastructure making it cumbersome to gather solar energy from over a large geographical area.

### Gathering Large Scale Solar Power From Space

Collecting large amounts of solar energy from space has been an engineering endeavor that has been making definite progress. Among the significant patents, the approach used by U.S. Pat. No. 3,781,647A, US20160056321A1, U.S. Pat. Nos. 10,340,698B2, 10,992,253B2, 10,144,533B2 attempt to use solar panels/tiles in space and then convert the harvested solar energy into radio waves which can be harvested at collection stations down at earth. There are several modifications to the basic idea that atmospheric obstructions reducing effectiveness of photovoltaic conversion can be avoided by converting light to electrical power in space, and the power can then be beamed down to earth for consumption. This and related approaches suffer from higher capital cost as raising relatively heavy solar panels to the orbit is extremely inefficient. The present application describes an indirect reflection based approach which can be implemented at a fraction of capital cost by using relatively lightweight satellites which have highly reflecting foils to reflect sunlight at scale onto the floating oceanic energy conversion and transportation devices. The effects of weather can be minimized by aiming the reflection at the devices that are in fair weather area of the earth. In this manner the present application achieves the main benefits of the established approach, in an alternative manner, and at a fraction of the cost.

The principle of reflection and the fact that a reflector in orbit is cheaper than a photovoltaic cell in orbit is explained in U.S. Pat. No. 8,596,581B2. However, the reflected sunlight in this approach is sent to the moon to be converted to electricity, and the focus of the patent is also on the distant future where the concept of massive sunlight reflection and concentration is used to power operations on moon and the transmission to earth happens via the moon. In contrast, our invention is immediately deploy-able. Notice the danger of concentrating sunlight and sending it to collection points on earth. Incorrect focus may cause danger and loss to life and property, and that appears to be why the reflection based approaches were not suitable for using on earth in the context of space power collection. However, since our devices are in the ocean floating with the currents, safely distant from human population, the focused reflected sunlight can be directed onto our energy collection device safely and for a fraction of cost of alternative past approaches. With the concentrated sunlight reflection approach claimed in this specification, and by using the energy collection and transportation device of this invention, one can de-carbonize the world economy to a large degree within a decade.

Yet another approach for concentrated reflection and then photovoltaic conversion is documented in CN103868246A, CN109831145B. While conceptually interesting and clearly having engineering depth, the authors have failed to convince a kilometer scale mirror could be made economically in orbit and that too with required accuracy. The lack of translation of their vision into reality despite the backing of one of the worlds most prestigious space organizations shows that these challenges are hard to surmount in practice. In contrast our space helper is able to maintain proper curvature at scales orders of magnitude larger and with great accuracy as shown in later sections of this application.

There are yet other smaller scale space photovoltaic designs which all have their own merit but do not interfere with the claims in this application as the scale of power being collected from space is several orders of magnitude larger than is possible with them. Among these, the salient design is CN113364148B.

In the same manner, there are smaller scale designs using reflection for concentration of sunlight in space which do not interfere with the claims in this application since our designs are exclusively applicable to size 1 km² and larger, which is strictly beyond the range possible with these designs. Salient among these are US20170025992A1, U.S. Pat. Nos. 10,992,253B2, 6,075,200A, JP6640116B2, WO2017027615A1.

### Utilizing Lightning and Static Electricity

U.S. Pat. No. 7,855,476B2 explains the issues involved in and the value in using lightning as source or renewable power even though the proposed solution works with static electricity instead of lightning. In general, the probability of lightning is small, and hence it doesn't become a reliable source of renewable power. However, there is a case for opportunistic exploitation of lightning power which is done in the present application. The approach taken is to take the lightning collection device into the storm where possible opportunistically as explained in the later sections. This fundamental difference of approach made possible by our floating energy harvesting platform.

Another approach to harvesting the power of lightning is presented in WO2013178973A1 where again the opportunistic ability to go into the storm and gather the lightning is missing, and therefore it represents a different independent non-conflicting technological approach to lightning energy harvesting.

The integrative approach to renewable energy where each known source is combined to extract energy in an optimized manner with minimal transportation costs while taking benefit of opportunistic energy extractions is the crux of the novelty of this invention.

### OBJECTS OF THE INVENTION

Collect solar energy over large areas by harvesting solar energy falling over the oceans. Ocean currents may be used in order to minimize the transportation cost, as described. This application also harvests and transports renewable energy: wind, wave, ocean-current, tidal-current, and lightning energy in an optimized manner.

### BRIEF SUMMARY OF THE INVENTION

The present invention, in general terms, harvests and transports renewable energy from the ocean or other convenient water body. A renewable energy extraction and transportation device floats on the water body surface and has the capability of converting solar, wind, wave, ocean-current, tidal-current, and lightning energy into electricity, which is converted into Hydrogen through on board electrolytic cells and used to charge a rechargeable battery, or to Hydrogenate on board metal nano-particles so that the Hydrogen can be transported efficiently as solid metal hydrides. Several metal mixes are possible, e.g.: Al doped with Ti or Fe or Ni or Co mixed with Mg, etc. and can be chosen depending on the requirement, the cost and the yield of the particular mix. The device is designed to withstand rough ocean conditions and is expected to be away for several months at a time when it generates the solar energy and stores it as compressed hydrogen, solid metal hydride, and/or a charged battery.

The renewable energy harvesting and transportation device, has a floating platform with positive buoyancy so that it can carry load of the other constituent parts. The device also has on-board array of seaworthy solar panels, wind turbines, wave energy gathering parts, and a lightning energy gathering conductor. Of these parts, the wind turbines and the solar panels can be retracted into a tucked-away position where they will remain mechanically closed and submerged under the water surface in order to protect them from rough weather conditions. These energy gathering parts convert the energy into electricity to be used by rest of the device. Optionally, the panels are reflective and have a focusing saw mirror pattern so as to collect the unused reflected solar energy for additional harvesting of reflected light energy through a solar panel as well as harvesting heat energy through high temperature electrolysis.

The electricity harvested by the energy gathering parts is routed to an electrolytic cell that operates at a considerable depth under the ocean surface in order to produce the hydrogen compressed at the ambient water pressure present at the depth of operation. The electricity is also optionally used for high pressure high temperature electrolysis in a sealed electrolytic cell. The electricity is also used to charge an on-board rechargeable battery. The compressed Hydrogen is also optionally reacted with metal mix nano powders to store the Hydrogen in the form of solid metal hydrides.

The compressed hydrogen produced by the electrolytic cell(s) is collected in compressed hydrogen storage tanks which also provide buoyancy to the device. The device also has an on-board computer system and electrical motors to do various operational tasks. Tasks include actions like folding up and submerging the solar panels for bad weather or dark conditions or navigating on the sea surface by operating propellers. These operate either by drawing some power from the on-board solar panels, or by using batteries during dark conditions. The on-board computer will have visual and other sensors and will be designed to both remote control the system as well as to operate it autonomously without human intervention for long periods of time.

### BRIEF DESCRIPTION OF THE DRAWING

Non-limiting embodiments of the present invention are described by way of example with reference to the accompanying figures, which are schematic and are not intended to be drawn to scale. In the figures each identical or approximately identical component is represented by a numeral. For purposes of clarity not every component is labeled in every figure, nor is every component of every embodiment of the invention shown where illustration is not necessary to allow a person of ordinary skill in the art to understand and build the invention. The figures are the following:

FIGS. 1 and 2 show the different side views of the device converting renewable energy into compressed hydrogen. FIG. 3 shows the top view of the same.

FIG. 4 shows the top view and the side view of the sealed high pressure electrolytic cell.

FIG. 5 shows the open electrolytic cell which operates under hydrostatic pressure.

FIG. 6 outlines the hydrocarbon pathway that uses the heated compressed hydrogen for converting waste into useful fuel gases.

FIGS. 7A-7B show the side views of device with solar panels floating and with solar panels submerged, while the FIGS. 7C and 7D show the top view of the device with solar panels floating and with solar panels submerged.

FIG. 8 shows the forces on the device in a top view, along with the limits to which the force vectors may controlled to fit a desired trajectory on the ocean.

FIG. 9 shows a composable embodiment of the device. Here the device has a capability to form a flat semi-rigid floating surface by having a hard joint on the mating parts as shown in top-view in FIG. 10a. The details of the mating part are shown in FIG. 10b.

FIG. 11 shows the cross sectional detail of the floating solar farm.

FIG. 12 shows an optional add-on device, the orbital solar reflector device, which increases the incident sunlight falling on the device.

FIG. 13 shows a lightning harvesting circuit.

### DETAILED DESCRIPTION OF THE PREFERRED EMBODIMENTS

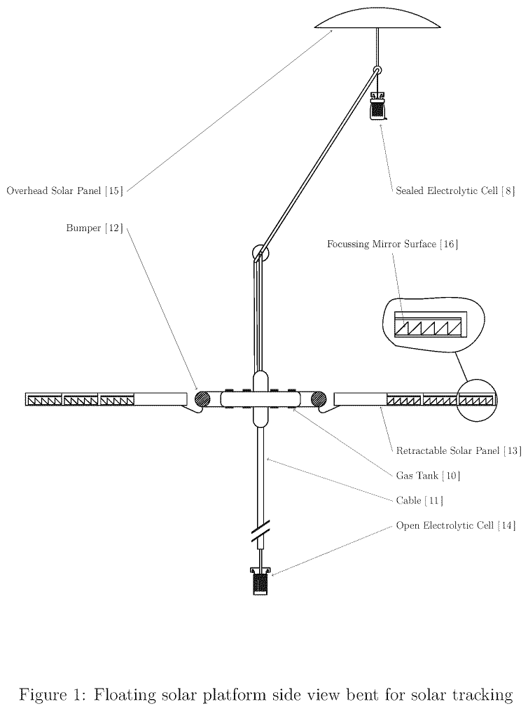

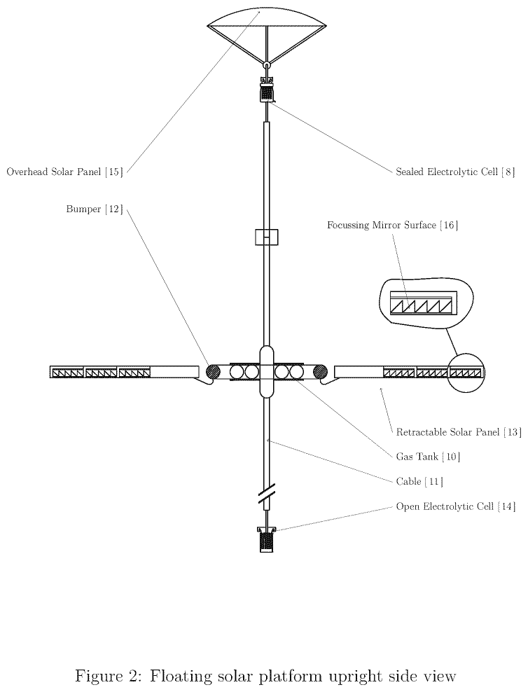

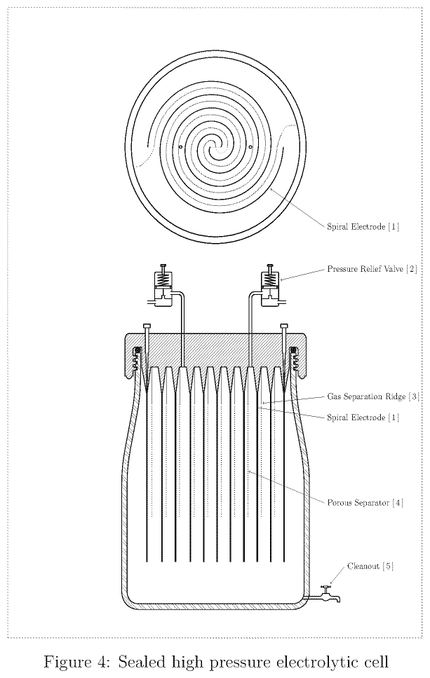

The sketch in FIG. 1 shows an exemplary arrangement of the preferred embodiment for the invention. The device has one or more cylindrical buoys which also serve as Gas Tank [10] and are referred as such in the remaining discussion. The Gas Tank [10] stores the hydrogen produced by the device. There is an attachment on one side for the submerged payload which is attached to the buoy. The platform has an upright pole on the other end which rises above the water level and serve as a mount point for the Sealed Electrolytic Cell [8] (see FIG. 4) while also providing drag force passively because of the wind in the vicinity of the device. The device also has the capability of providing variable drag force by using the wind-mill with variable angle of attack blades to provide variable drag from the incident wind. The device also has commercially sourced radio antennae, sensors, and cameras which are not specifically described.

One potential embodiment of the platform is in the form of a cylindrical buoy with a buoyancy of 5000 kg. The volume of such a buoy is approximated below by using a cylinder instead of the spherical end of the buoy. Similarly, density of 1.0 kg l-1 is used instead of the density of sea water which can vary with temperature and salinity.

$$V = 5000 kg / 10 kg {I}^{- 1} = 5000 I \qquad ( 1 )$$

The cylinder can have a radius of 0.8 m which gives the height of cylinder to be 2.486 m. Construction of ocean-worthy buoys is a well developed standardized industrial process. This embodiment proposes to use a buoy made with 10 mm stainless steel sheet with standard processes.

The weight of such a buoy is approximated using the surface area of the cylinder and using 8000 kg m-3 as the density of steel. The buoy weighs approximately 1160 kg, and has sufficient buoyancy to carry a payload of 3839 kg, as shown in

TABLE 1
Steel buoy design (representative)

| Component | Description with units (SI) | Value |
|---|---|---|
| Buoy | Volume (liters) | 5000.000 |
| | Radius (m) | 0.800 |
| | Height (m) | 2.487 |
| | Curved area (square meter) | 12.500 |
| | Flat area (square meter) | 2.011 |
| | Total surface area (square meter) | 14.511 |
| | Thickness of steel (m) | 0.010 |
| | Volume of steel skin (cubic meter) | 0.145 |
| | Density of steel (kg/cubic meter) | 8000.000 |
| | Weight of buoy (kg) | 1160.849 |
| | Carrying capacity (kg) | 3839.151 |

Table 1. Positive bouyancy is achievable with a number of combinations of buoy parameters and payload weight.

The entire device is expected to float on the ocean surface while at the same time being dragged in ocean currents by virtue of the drag felt on the Cable [11] and the Gas Tank [10]. These devices shall be placed in those areas of the ocean where the ocean currents naturally form a loop. Fortunately, many such ocean current systems exist. Using the ocean current allows one to harvests and transports renewable energy from over a large area as well as to transfer it cost-free to a convenient collection location.

In order to keep the device on its desired trajectory, the floating platform also has navigational capability. This is effected either through commercially available onboard computer control, or through commercially available remote control by human operators. This requires propulsion and control, GPS capability, cameras, and other standard navigation and communication devices. Since these are well developed technologies, we will use existing prior art to add these capabilities to the device.

TABLE 2
Physical Properties of Compressed Hydrogen

| Component | Description with units (SI) | Value |
|---|---|---|
| Quantity of | 1 atmosphere in N per sq m. | 101325 |
| Hydrogen | Pressure of hydrogen in | 400 |
| | atmospheres | |
| | Pressure (N per sq m) | 40530000 |
| | Volume of Tank (cubic m) | 0.1 |
| | Absolute temp of deep sea (K) | 275 |
| | Molar gas constant R (J/kg K) | 0.167 |
| | Number of moles of gas in | 88133.316 |
| | the cylinder i.e. Volume of | |
| | tank above, as per the gas | |
| | law: n = PV/RT | |
| | Mass of one mole of H2 (kg) | 0.002 |
| | Mass in kg of compressed H2 | 177.666 |
| | in the cylinder | |
| Buoyancy of | Volume of water displaced by | 0.100 |
| the tank | tank (cubic meter) | |
| | Density of deep sea water | 1055.000 |
| | (kg per cubic meter) | |
| | Weight of water displaced | 105.500 |
| | The weight already provided | 177.666 |
| | by compressed hydrogen | |
| | Effective weight H2 contained | 72.166 |
| | in the cylinder (kg) | |
| Energy | Hydrogen combustion energy | 141.800 |
| content | (MJ/kg) | |
| | Mass of hydrogen in tank (kg) | 177.666 |
| | Total energy from 100 L tank | 25193.065 |
| | (MJ) | |

Table 2. Physical Properties of Compressed Hydrogen

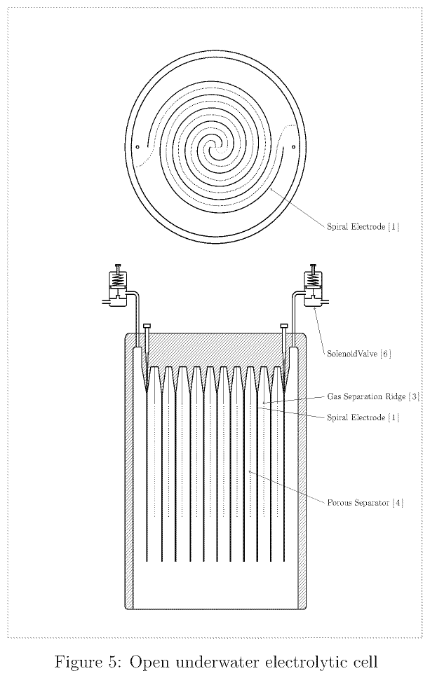

The electrolysis of sea water is done at the ambient deep sea pressure as shown in FIG. 5. This allows one to create and store compressed hydrogen without having to expend energy for compressing it. Considering electrolysis at a depth of approximately 4 km, i.e. approximately 400 atmospheres pressure, the Hydrogen created through electrolysis of sea water would be emitted through the SolenoidValve [6] which opens when the hydrogen bubble reaches the bottom of the Gas Separation Ridge [3]. The valve would close when the water level reaches to the top. The solenoid valve as well as the sensors and control for closing and opening the valve at appropriate levels are commercially available. The released hydrogen has the physical properties as described in Table 2, and is at a compression level suitable for use in transportation or industry.

An alternative embodiment allows the electrolytic cell to build up additional internal pressure by forcing electrolysis within a sealed space. As shown in FIG. 4, the electrolysis is within a constrained volume. Converting the entire water into hydrogen would compress the hydrogen at approximately 1240 atmospheres pressure as per the ideal gas law at 273K. Using a Pressure Relief Valve [2], the produced hydrogen is harvested at 700 atmospheres. The sealed electrolytic cell is constructed in such a way that the two Spiral Electrode [1] spiral around each other, thereby providing increased surface area for electrolysis. Opposite polarity electrodes are separated by a spiral ridge like shape, the Gas Separation Ridge [3] on the bottom surface of the top lid of the electrolytic cell. Water level is prevented from falling below the ridge line in order to prevent mixing of the gases. When water reaches this threshold, additional water is pumped in through a separate inlet at 700 atmospheres, the opening pressure of the relief valve. This causes the hydrogen to flow out at the same 700 atmospheres pressure through the relief valve until the water level rises to a top threshold level which is chosen so as not to overflow at the normal closing rate of the pumped in water. The pumping of water at high pressure is done with commercially available hydraulic systems, and the high level, low level transitions to drive the water pumping are also done through commercially available control systems.

The electrolysis of sea water and brackish water produces chlorine at the positive electrode. Chlorine liquifies at the operating pressure of the cell. Being heavier than water it shall sink and be discharged through the Cleanout [5]. Continuous depletion of chloride ions makes the remaining solution alkaline thereby suppressing the production of corrosive chlorine at the positive electrode.

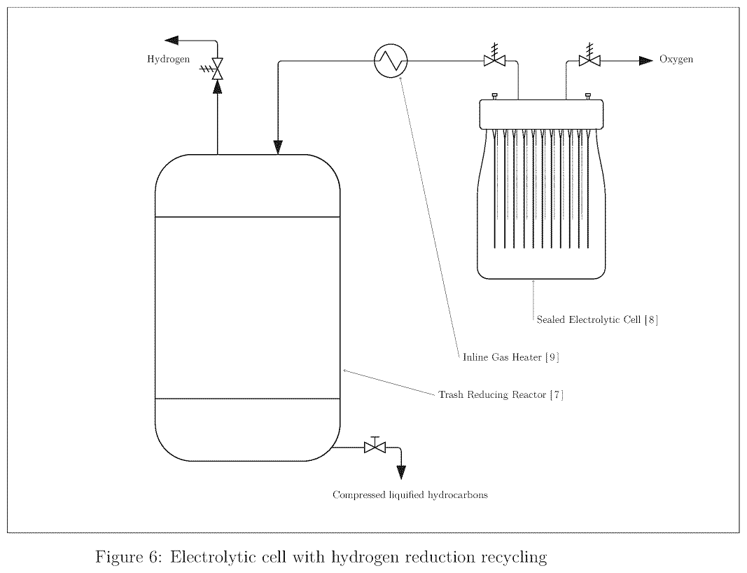

Yet another alternative embodiment works by harvesting hydrogen at a pressure of 1000 atmospheres and then transferring it into a waste reducing chamber containing ocean plastics or household waste or other carbon rich waste, as shown in FIG. 6. The hydrogen is heated, approximately to 700K (430C or 800F) by the Inline Gas Heater [9]. The mixture is turned, exposed to ultra-violet light to encourage reduction reactions which are endothermic and perform better under catalysis and high pressure. The resulting gas is a mixture of Hydrogen, Methane, Methyl alcohol, Water vapor etc. along with some inorganic compounds. This mixture is cooled to 300K and then expanded to 700 atmospheres. By the ideal gas laws, the resulting adiabatic cooling results in the gas being cooled to 210K. This cool gas mixture at −63C and 700 atmospheres pressure is distilled to extract out the methane which ceases to be gaseous under those conditions. This pathway and embodiment would allow the conversion of oceanic plastic and oil spills, mixed domestic trash and other carbon rich waste into methane gas that can be used in place of natural gas for heating and power.

The various preferred embodiments described previously for the electrolysis cell assembly can be made further energy efficient by using the waste heat of traditional nuclear or thermal power plants to reduce the need for electrical energy required for electrolysis as well as that required for the thermal formation of methane from organic and plastic waste matter.

The Retractable Solar Panel is attached to the device as shown in FIG. 1. The solar panels can be folded and then with a hinge can be turned downwards to go under the water surface when not it use or to protect them from rough seas. This requires the solar panel to have neutral buoyancy, which can be achieved by traditional design methods. The arc of the circle away from the maximum opened state of the solar panels is used to attach Bumper [12] which will protect the solar panels when they are in a closed downward position.

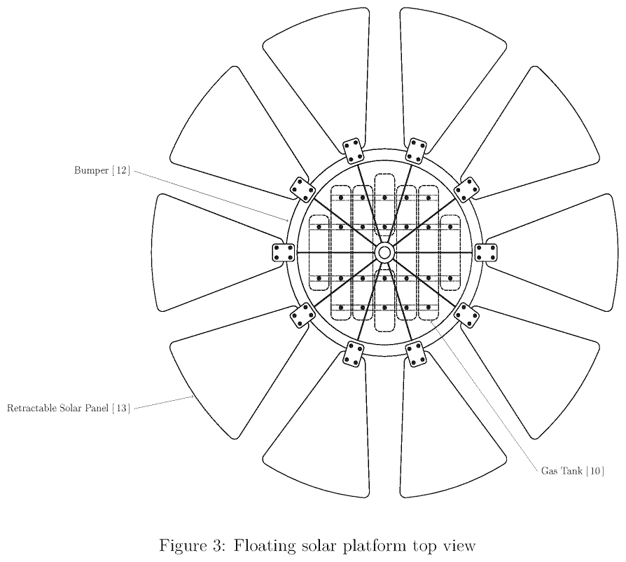

The Retractable Solar Panel [13] is designed with focusing reflective backing, the Focusing Mirror Surface [16] so that some of the sunlight falling on the solar panel is reflected back towards the suspended Sealed Electrolytic Cell [8]. Some of this radiation is converted to electricity by the Overhead Solar Panel [15] which moves to do approximate solar tracking as indicated from FIGS. 1 and 2 This allows the use of solar heat as well as photovoltaic electrical power to perform electrolysis of water. An additional benefit of the reflection is that solar heat instead of falling on the absorbing sea water is reflected away, additionally reducing to a miniscule degree the warming of the ocean. The electrical power generated by the solar cells is also transmitted down to the Open Electrolytic Cell [14] which collects Hydrogen through the Cable [11] but allows Oxygen to bubble away into the sea water.

The device uses electrolytic cell technology for the electrolysis of sea water. Similarly, the transmission of electrical power over 4 km long wires and conversion of voltages to meet electrolytic requirements are also built using standard well known engineering methods.

The device uses an electrolytic cell as described in U.S. Ser. No. 17/146,390 and U.S. Ser. No. 18/763,455.

The device uses a strong sea water resistant cable with features as described in U.S. Ser. No. 17/146,390.

### Solar Raft

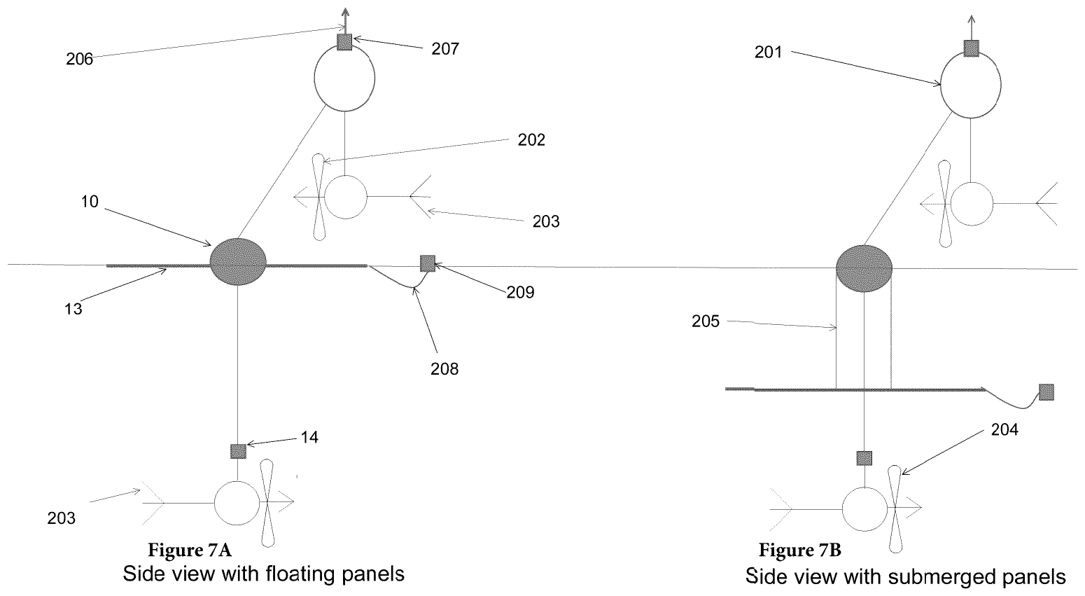

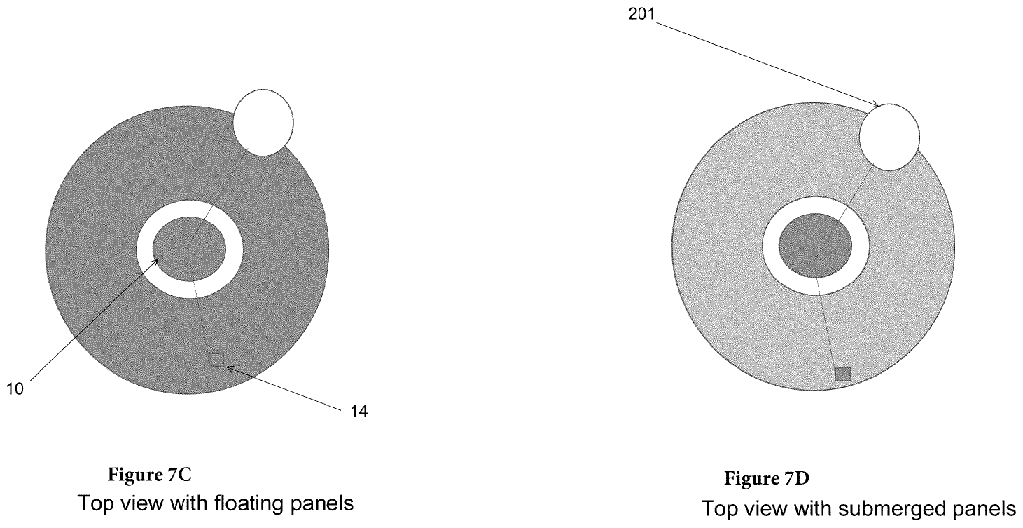

Yet another exemplary arrangement of the preferred embodiment for the invention, called the Solar Raft has an embedded battery and a solid hydride micro reactor so that the renewable energy produced by the device can additionally be stored as electro-chemical energy of the charged battery, and as hydrogenated metal hydrides that release Hydrogen on demand from the micro-reactor. The solar raft is made of a convenient size for manufacturing, transportation and assembly, and would therefore change with product maturity. The solar raft can have circular or hexagonal shape as shown in FIGS. 7A-D and 9. Current manufacturing technologies allow fabricating solar rafts with maximum diameter of 5 to 15 m at this time. The ranges are expected to expand with time to as large as 100 m or 150 m, manufactured in shipbuilding docks kind of facilities having access to launching facilities.

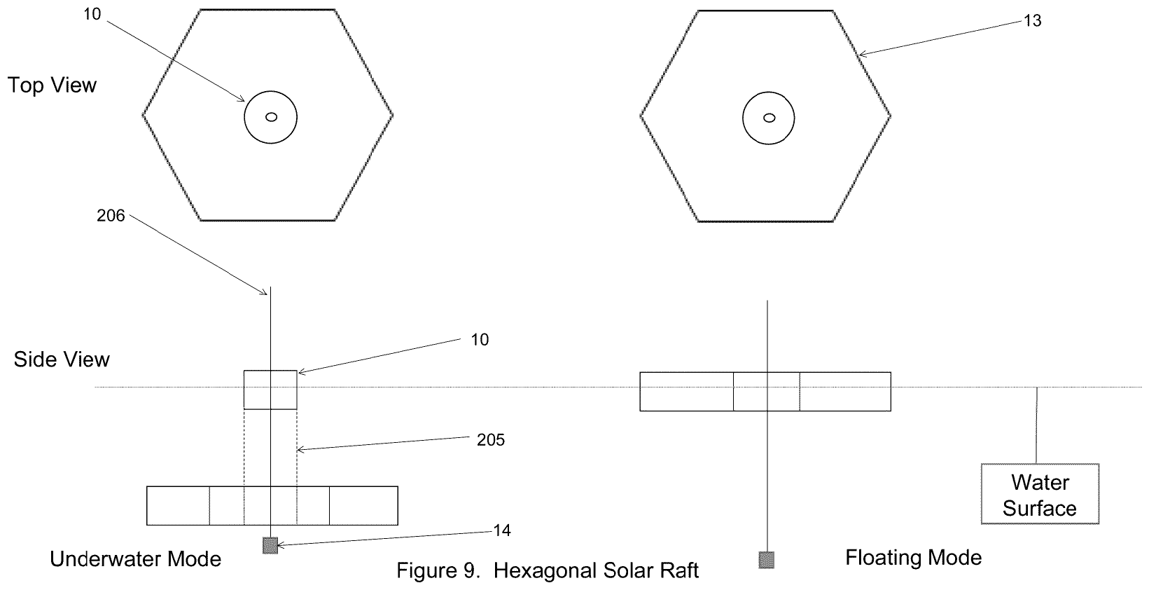

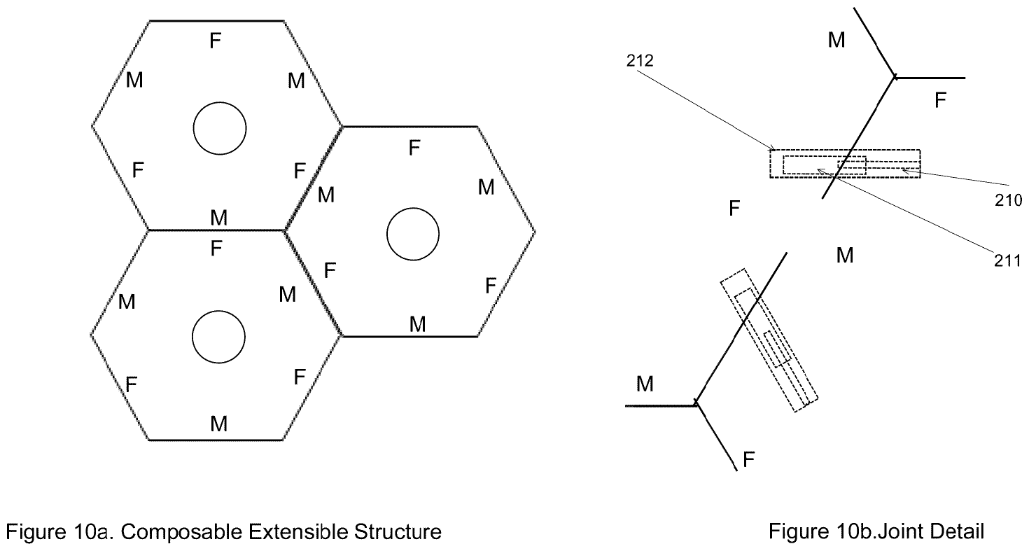

Several of these Solar Rafts can be connected in a packed manner as shown in FIG. 9. The connection of solar rafts requires that mating surface have opposite mating polarity, which are labeled as M and F respectively. As shown in the FIG. 9, the mating surfaces have a load bearing joint involving the Retractable Piston [211] and the Mating Cylinder [212]. The Retractable Piston [211] is mounted on a fixed Mounting Pillar [210]. By moving along this mounting pillar the piston can either remain retracted or be engaged with the matching cylinder to join the solar rafts. It can be noted from the relative direction of motion of the piston that once the two surfaces are properly aligned are mated, moving them apart is not possible. The direction of movement of the Retractable Piston [211] is such that once engaged with the Mating Cylinder[212], the mated sides can not be released without retracting the part piston. The thickness of the piston is expected to from 4 inches to 8 inches at which thickness it sufficient strength to take the force of landing of modern executive or military jet. Thicknesses up to 12 inches will permit take off and landing of transport aircraft as well.

Since these various rafts connect to each other in a packing manner, any large shape can be constructed by combining different numbers and arrangements of solar rafts. Specifically, a landing strip for landing aircraft or drones on the ocean can be constructed by using a very long assembly of such solar rafts.

Since the devices have stored electrochemical energy in the battery and also the compressed Hydrogen which can be used as fuel, the devices can also serve as ad-hoc fueling depots for aircraft, drones and ocean faring vessels within the ocean.

The wind mill [202] allows controlling the amount of wind drag felt by the device. This optional feature is implemented in two ways. First the angle of attack of the wings on the wind mill is controllable so that it can either put up more resistance to the wind or less. Secondly the internal resistance to rotation of the shaft holding the wind mill is variable. Varying this allows a degree of control on the drag felt by the wind mill. The drag change in turn allows controlling the total force felt by the device. And these variations are used to control and keep the device on track on its desired trajectory. Just like the magnitude of force vector can be changed by the two approaches described earlier, a lateral force can also be applied by the rudder [203]. Therefore both direction and magnitude of the total force vector are controllable and used to adjust the progress of the device along its trajectory.

The wind drag felt on the Hydrogen filled balloon [201] is variable because wind direction and magnitude change with height. The height of the balloon is varied by routing some of the Hydrogen from the storage tank [10] into the balloon. As the balloon is inflated it rises more, and thus faces greater force at higher height, and potentially with a different wind direction. The other way the balloon height variability contributes to optimality of the energy gathering trajectory of the device is by its usage as the harvester of lightning energy. As the thunderstorms are predicted in the path of the device, it can speed up to put the balloon in the path of potential lightning strike in order to opportunistically gather the lightning energy for harvesting. The available power within the lightning bolt reduces as it comes closer to the earth (because the power was used up in heating up the air to cause the thunder). Since the proposed device is able to harvest lightning at height using the Hydrogen filled balloon [201], the amount of harvest-able energy is larger as compared to past approaches.

Another way of controlling the forces on the device is to vary the depth of the submerged electrolyzer [14]. Increase or decrease of depth of electrolyzer allows control of the amount of ocean current drag felt by the device because both the speed of the current is different at different depth, and also a greater length of the cable feels the drag caused by the current. Additionally, the submerged water turbine allows controlling the water current drag felt by the device.

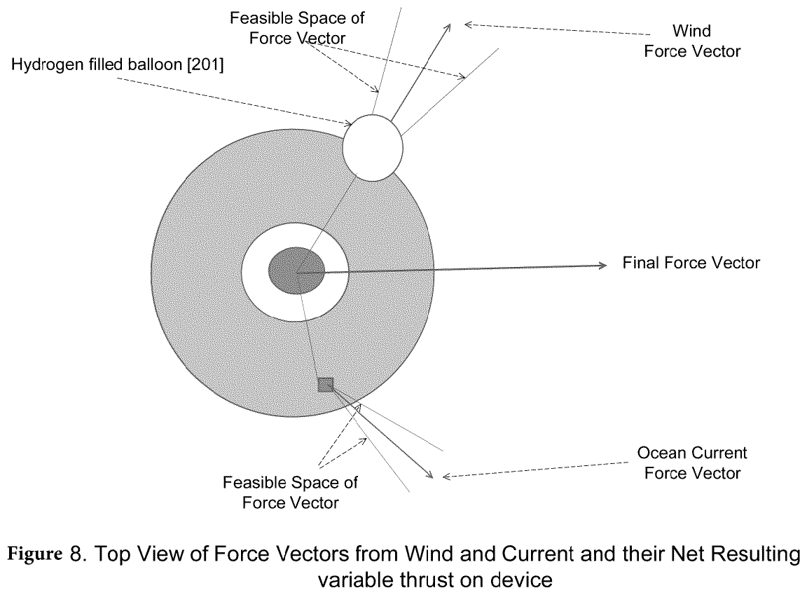

Together these controls allow one to vary the total force on the device as shown in FIG. 8. Controlling the various drag forces allows the device to slow down, or to catch up along its trajectory, as well as to control the direction of the net force incident on the device. Additionally, when the wind mill and water turbine are deployed, these renewable sources of energy are used not only for transporting the energy efficiently, but also for directly generating electrical power which is stored and transported.

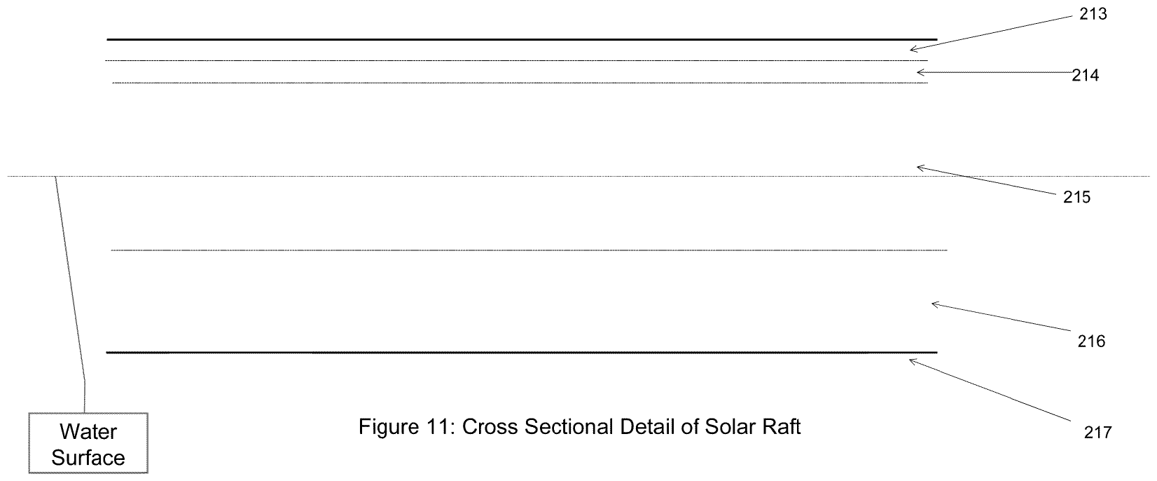

The solar-raft consists of several layers as shown in FIG. 11. The Outer Layer [213] provides sea water chemical resistance and also includes a Fluorescent material suspended in transparent resin in order to convert the unabsorbed ultraviolet and violet-blue part of the spectrum into lower wavelengths for better absorption by the following photovoltaic layer [214]. The next layer is the electrolyzer stack [215] where several microelectrolyzers of the sealed electrolytic cell [8] form are installed. These electrolyzers take advantage of wasted heat at the previous stage as described in U.S. Ser. No. 18/763,455. The next layer which effectively sandwiches the electrolyzer layer is the battery or solid hydride storage layer where Hydrogen is stored in metal Hydride form for further usage as already described in U.S. Ser. No. 18/763,455. Or commodity batteries are used to store spare electrical energy. The wasted heat while batteries are charging is transmitted back into the electrolyzer layer where it is productively used to produce more Hydrogen. This novel use of waste heat of battery charging for efficient Hydrogen production is yet another novel contribution of this application.

### Harvesting Wave and Lightning

Harvesting wave energy is done when the device is in submerged panels position as shown in FIG. 7B. The Retractable Cable [205] is designed to be flexible and also has piezoelectric current generating circuits embedded within the cable (this is relatively economical technology and its used to light up bouncing balls and children's shoes). As the cable flexes these crystals generate electrical pulses which are then harvested and transported as described previously.

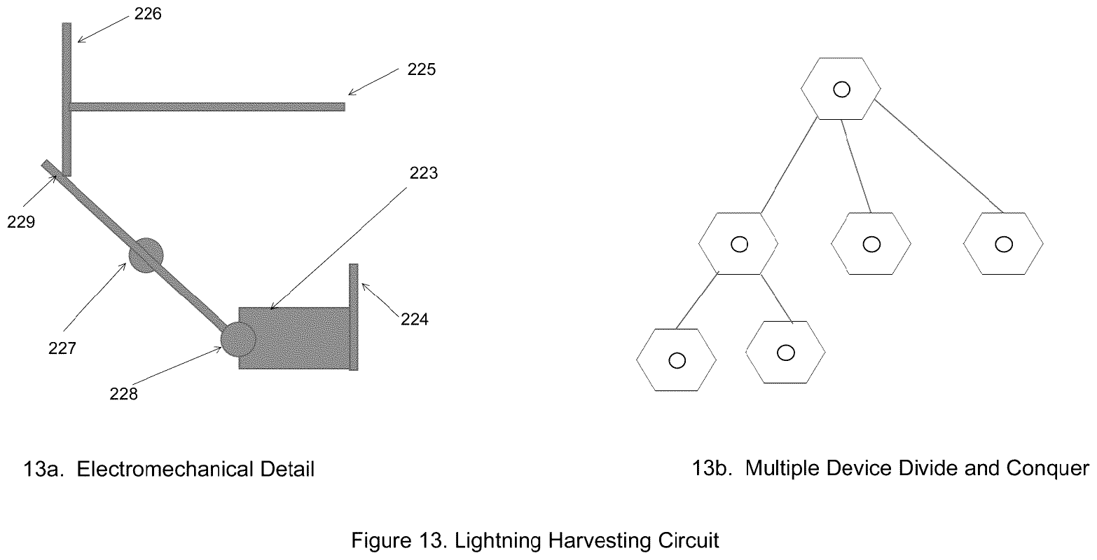

The lightning harvesting capability of the device is explained in FIG. 13. The relative position of the lightning harvesting circuit [207] in one embodiment is also shown in FIG. 7A. The circuit is explained in FIG. 13a. The lightning harvesting circuit receives the lightning bolt from the Lightning collection terminal [226]. As the bolt gains strength and huge amounts of current start flowing into the circuit, the branch going towards the device collection remains connected for a short while but then gets disconnected at the Transient disconnect [229]. The disconnect operates because once the current starts slowing through it, the current flows through the Conducting Spring [223] which would usually be compressed and keep the Transient disconnect engaged. However, as the current flows because of the presence of a strong axial magnetic field (generated by static or dynamic state of the art magnets not shown in the Figure) there is an axial force on the spring which causes the disconnect [229] to get disconnected. In the FIG. 13a as the spring moves rightward, the movement in the Non conducting fulcrum joint [227], and the Conducting joint with rotational freedom [228] causes the disconnection to occur. Thus, as the lightning bolt strikes, the initial part of the bolt is partially harvested locally as a smaller pulse which is available at the Local high voltage pulse harvesting terminal [224]. Downstream this high voltage and relatively low current pulse can be run through transformers to step it down into a low voltage high current pulse that can be harvested normally in the device after some electrical smoothing including short term storage in capacitors.

The waste branch of the lightning bolt which remains engaged even after the Transient disconnect [229] has fired is fed either into the ocean (i.e. electrically earthed) or is fed into as many as 6 neighboring devices through the connections: Lightning Cable [208] and Solar Raft Inter Connect [209] shown in FIG. 7A. The details of cables and multijunction connectors and not further discussed in this application. As the electrical output of the lightning bolt which is available on Peer terminal [225] of the circuit is shared with additional devices, the same lightning harvesting circuit in other devices takes away part of the punch, and this process proceeds recursively as shown in FIG. 13b. This approach represents the first known way to harvest large quantities of lightning energy with a high level of efficiency and safety.

### Satellite Reflector

While these devices are on a trajectory, their effectiveness can be increased dramatically by having a system of satellites in earth orbit which have large very light highly reflective foil which reflects incident sunlight down on to the floating devices thereby increasing their effectiveness and also enabling them to produce photovoltaic power even at night.

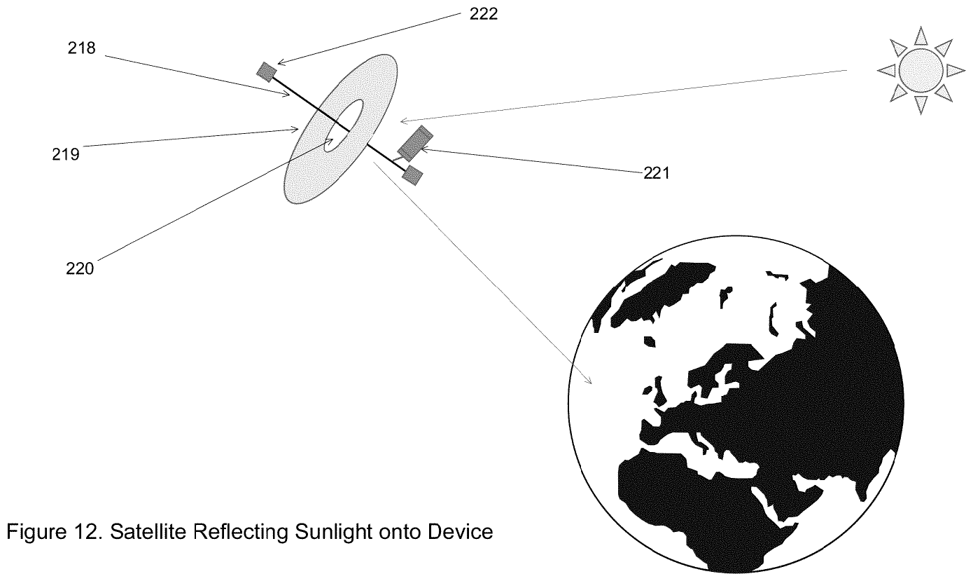

As shown in FIG. 12, the optional helper satellite has a flat donut structured reflecting foil [219]. The whole satellite is rotating slowly along the axis so that the centrifugal forces stretch out the reflecting foil. The satellite also has an on-board solar panel array [221] which is used for powering its local in-orbit maneuvers and operations and is not discussed further. The present technology allows reflecting foils of a few micrometer thickness. The reflector has a radius of 5 km-100 km. Considering the canonical size of 30 km radius, the area of the foil is 30.10³*30.10³*3.14 ignoring the central hole. A square meter of aluminum metal foil with 5 micro meter thickness weighs 5*10⁻³ cubic meter*2710 or 13.55 gram. Thus the reflector of 30 km radius weighs about 900*3.14*10⁶*13.55*10⁻³ kg i.e. 38,292 metric tonnes. Using a present time estimate of $5000/kg to launch to orbit, this represents about $191 billion of cost. However, the sunlight falling on the 30 km radius foil is also significant. Sunlight intensity is about 1376 W/m² in space. Thus the total power being reflected down for additional more efficient harvesting is 1376*900*3.14*10⁶ i.e. 3888 GW of power. Even considering 50% net efficiency the effective cost per Watt is: 2*191*10⁹/3888*10⁹ i.e. 10 cents per watt—for the life of the reflector, which leads to the possibility of harvesting 388 GW or more of power and drastically reduces the price of energy. By comparison, the peak power consumption of New Jersey, Maryland, Pennsylvania is not even 100 GW. Such a low orbital power concentration cost beating the terrestrial one by orders of magnitude is totally a game-changer. It allows an economical way to scale up the effectiveness of the device by low multiples of 4× to 20× and thereby makes solar energy economical to a cost below all existing forms of energy.

The wave nature of light creates additional complications while focusing the incoming solar beam so as to have a higher concentration when it falls on the energy harvesting device floating in the ocean. Given the reflector diameter of 30 km, and distance to target device say 1000 km, the minimum resolvable angle for green light with wavelength 565 nm is 1.22*565*10⁹/30*10³ or 2.3*10⁻⁵ radians by the Rayleigh criterion. At an orbital distance of 1000 km the corresponding best focal spot is of the size 2.3*10⁻⁵*1000*10³ m=23 m. But for the desired intense magnification of 20× the focal spot has to be only 4.47 times smaller than 30 km i.e. 6.71 km. Hence the reflector helper is large enough that the desired focal concentration of sunlight can be achieved. As can be observed by the above representative values, this represents the first feasible planetary scale exploitation of solar energy from space. The reflector may be aimed at a fixed device (e.g., the device may be fixed at a location in near shore, such as at a predetermined location from the shore).

Even though the wavelength does not prohibit focusing the light reflected from the foil [219] onto spots of size 23 m or greater, there is still a very great technical challenge in achieving very low curvature able to focus the beam at a spot 1000 km away or more. In the present application, the helper space device has two Charged Control Bodies [222] which are charged with opposite polarities. The foil is charged with a polarity same as that of the Charged Control Body away from the earthward side. This creates a force on the foil because of electrostatic force. This makes the foil slightly concave with the concavity proportional to the amount of electrostatic charge applied. As the foil rotates, every part of the foil must remain in equilibrium with the application of both centrifugal force and electrostatic force. This causes the foil to curve in a parabolic manner approximately. The charge level is controlled so that the focal spot on the ocean hydrogen device is of the proper concentration. This represents the first known way of achieving planetary scale high quality concave and convex mirrors which can be used in various forms of geo-engineering.

Space environment has solar wind which essentially is a stream of charged particles which can over time tarnish the mirror finish of the reflector. The solar wind is affected by the charged control bodies which pull the wind away from the reflector. Additionally, the Satellite core [218] also sets up a strong magnetic field along the axis of the core. As the solar wind approaches the field, it is forced to enter the field close to the poles just like the solar wind is forced to enter the earth ionosphere close to the poles causing the auroras. The stream of ions passes through the donut hole within the reflector [220]. In this manner the charged particles are steered away from the reflector thereby increasing the life of the reflector.

While these devices are on a trajectory, they can not only harvest and transport the power, but also transmit them directly into microwave form to a suitable earth orbit satellite. The technology to transmit the energy via microwaves from satellites carrying solar panels has already been shown in practice (https://www.caltech.edu/about/news/in-a-first-caltechs-space-solar-power-demonstrator-wirelessly-transmits-power-in-space). The approach used and claimed by our invention is a complementary one. The surplus power from the device is converted into microwave and aimed at the earth orbit satellite, which in turn transmits the received energy down to usage points as already shown by the Caltech demonstration.

### Solar Roof

The exact same arrangement of the energy storing elements described in FIG. 11 can be re-purposed to form a solar roof. The shape of the solar roof will be arbitrary composed in terms of simple polygons. The solar roof is water and shock resistant by design since Solar Raft is and can serve as an economical value adding building component which not only provides shelter but also converts the ambient solar heat into surplus green hydrogen and also stores energy as a battery. The roof determines the mix of energy to be saved in the battery vs converted to Hydrogen via electrolysis in order to operate the system at maximum efficiency in a variety of weather conditions and also based on the remaining capacity in the battery vs the gas tank.

The Solar roof can benefit further by supporting additional functionality through the heat storage layers as described here. Beyond the initial layers of Solar Cell, Electrolyzer, Battery, there is a series of heat exchange layers and heat sinks operating at different temperatures. These layers are able to have active heat exchange with the inside of the home via vents on the downside of the roof, thereby also providing low quality but economical and almost passive climate control.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall there between.

### PARTS

1 Spiral Electrode
2 Pressure Relief Valve
3 Gas Separation Ridge
4 Porous Separator
5 Cleanout
6 Solenoid Valve
7 Trash Reducing Reactor
8 Sealed Electrolytic Cell
9 Inline Gas Heater
10 Gas Tank
11 Cable
12 Bumper
13 Retractable Solar Panel
14 Open Electrolytic Cell
15 Overhead Solar Panel
16 Focusing Mirror Surface
201 Hydrogen filled balloon
202 Wind mill
203 Rudder and tail assembly
204 Water turbine
205 Retractable Cable
206 Lightning conductor
207 Lightning Harvestor Circuit
208 Cable Sharing Lightning with Neighboring Solar Raft
209 Solar Raft InterConnect
210 Mounting Pillar
211 Retractable Piston
212 Mating Cylinder
213 Outer Fluroluminiscient Sea Water Resistant Layer
214 Solar Photo-voltaic Layer
215 Electrolyzer Layer
216 Solid Hydride and/or Battery Storage Layer
217 Sea Water Resistant Rugged Insulating Outer Layer
218 Helper Satellite Stabilizing Core
219 Charged Thin Foil Metal Reflector
220 Hole for Handling Solar Wind
221 Light Spaceworthy Solar Panel
222 Charged Control Body
223 Conducting Spring
224 Local high voltage pulse harvesting terminal
225 Peer terminal
226 Lightning Collection Terminal
227 Non conducting fulcrum joint
228 Conducting joint with rotational freedom
229 Transient Disconnect

1. (canceled)

2. A system for collecting solar energy using ocean currents in an ocean for gathering the solar energy falling over a geographical area and transporting the gathered solar energy to a storage location, with the ability to apply-navigation in order to stay floating along a trajectory, the system comprising a device comprising:
a positioning system configured to determine geographical co-ordinates of the device wherein the geographical co-ordinates are different from the trajectory;
a camera and/or sensor configured to determine physical and/or meteorological conditions surrounding the device;
a transmitter configured to transmit the geographical coordinates and the physical and/or meteorological conditions to a control center;
an on-board computer configured to receive navigational instructions from the control center to the device to cause the device to take an action in order to correct a location of the device back to the trajectory;
at least one submerged component of the device submerged at a depth so as to gain traction from the ocean current, the at least one submerged component configured to vary in depth so that ocean current drag experienced by the at least one submerged component varies based on the navigational instructions; and
at least one floating component floating on a surface of the ocean, the at least one floating component configured to vary in height so that surface wind drag experienced by the at least one floating component varies based on the height above the ocean surface based on the navigational instructions.

3. The system of claim 2, wherein the at least one submerged component comprises an electrolytic cell configured to electrolyze sea water into hydrogen gas and oxygen gas.

4. The system of claim 3, wherein the at least one floating component comprises an assembly of solar cells configured to generate electrical energy from collected solar energy.

5. The system of claim 4, wherein electrical energy generated by the assembly of solar cells is transmitted to the electrolytic cell to electrolyze the sea water.

6. The system of claim 3, wherein:
the electrolytic cell comprises an anode and a cathode, wherein the anode and the cathode each form a spiral, wherein the spiral anode is spaced apart from and spirals around the spiral cathode wherein partial separators placed between the spiral anode and cathode keep hydrogen and oxygen gas separate, wherein the hydrogen and oxygen gases are released before bubbles of the gases mix; and/or
the device, by conducting electrolysis of dirty water, further comprises a waste treatment system configured to treat ocean waste collected by the device by reacting it in the electrolytic cell with the hydrogen gas produced by the electrolytic cell in order to form compressed liquefied hydrocarbons; and/or
the electrolytic cell operates at a pressure configured to liquefy chlorine produced at the anode, wherein the liquefied chlorine being heavier than water is configured to discharge through an outlet arranged proximate a bottom of the electrolytic cell.

7. The system of claim 1, wherein the trajectory comprises an ocean current configured to naturally move the device.

8. The system of claim 1, wherein the at least one floating component is configured to harvest lightning energy with the at least one floating component extended at a height above the surface.

9. The system of claim 2, further comprising a plurality of the devices floating over an area of the ocean.

10. The system of claim 9, wherein each of the plurality of devices is configured to connect to another of the plurality of devices.

11. The system of claim 10, wherein the plurality of devices are connected to one another to form a landing strip configured to receive an aircraft and/or a drone.

12. The system of claim 11, wherein the landing strip comprises a fueling station configured to fuel the aircraft and/or the drone using electrochemical energy and/or hydrogen stored by at least one device of the plurality of devices.

13. The system of claim 2, wherein the device comprises a plurality of layers, the plurality of layers comprising:
an outer layer providing sea water chemical resistance to the device;
a photovoltaic layer arranged beneath the outer layer comprising solar cells configured to generate electrical energy from collected solar energy; and
an electrolyzer layer comprising comprises an electrolytic cell configured to electrolyze sea water into hydrogen gas and oxygen gas.

14. The system of claim 13, wherein the plurality of layers further comprises:
a battery or solid hydride storage layer configured to store the hydrogen gas.

15. The system of claim 13, wherein the outer layer further comprises a fluorescent material suspended in a resin configured to convert unabsorbed ultraviolet and violet-blue part of the spectrum into lower wavelengths, which are absorbed by the photovoltaic layer.

16. The system of claim 2, further comprising:
a satellite arranged in orbit of Earth, the satellite comprising a reflective foil configured to reflect incident sunlight in a direction of the device.

17. The system of claim 16, wherein the satellite further comprises two charged bodies comprising a first charged body and a second charge body having opposite polarities, the first charged body arranged at an Earthward side of the reflective foil, and the second charged body arranged at a side of the reflective foil away from the Earthward side,
wherein the reflective foil is charged with a polarity that is the same as the polarity of the second charged body, such that an electrostatic force is created on the reflective foil to cause the reflective foil to arrange in a concave shape.

18. The system of claim 17, further comprising a controller configured to adjust a charge on the charged first body, the charged second body, and/or the reflective foil, wherein the shape of the reflective foil is configured to adjust based on the adjusted charge to change the direction of the reflected incident sunlight.

19. The system of claim 17, wherein the charged bodies are configured to re-direct a stream of charged particles of solar wind away from the reflective foil.

20. The system of claim 16, wherein the satellite further comprises a core passing through a hole in the reflective foil, the core configured to generate a magnetic field along an axis of the core, the magnetic field configured to cause a stream of charged particles of solar wind to enter the magnetic field at a pole of the core and pass through the hole in the reflective foil.

21. The system of claim 16, comprising a plurality of the satellites arranged in orbit of Earth, each of the plurality of satellites comprising a reflective foil configured to reflect incident sunlight in a direction of the device.
